(19) United States
(12) Patent Application Publication
(10) Pub. No.: US 2022/0110016 A1
(43) Pub. Date: Apr. 7, 2022

(54) MODIFIED INTERFACE CIRCUIT WITH ENHANCED COMMUNICATION PERFORMANCE

(71) Applicant: ARRIS Enterprises LLC, Suwanee, GA (US)

(72) Inventor: Sundar Sankaran, Saratoga, CA (US)

(73) Assignee: ARRIS Enterprises LLC, Suwanee, GA (US)

(21) Appl. No.: 17/491,587

(22) Filed: Oct. 1, 2021

Related U.S. Application Data
(60) Provisional application No. 63/088,155, filed on Oct. 6, 2020.

(51) Int. Cl. H04W 28/02; H04W 28/20; H04B 1/7093; H04J 3/06

(52) U.S. Cl. CPC H04W 28/0268; H04W 28/20; H04W 84/12; H04J 3/0658; H04J 3/0641; H04B 1/7093

(57) ABSTRACT

An electronic device (such as an access point) is described. This electronic device includes an interface circuit that wirelessly communicates with a second electronic device (such as another access point or a client or station that is associated with the access point), where the interface circuit is compatible with an existing IEEE 802.11 standard having a predefined maximum bandwidth or a corresponding predefined maximum sampling rate. During operation, the interface circuit may communicate with the second electronic device using a bandwidth or a corresponding sampling rate that exceeds the predefined maximum bandwidth or the predefined maximum sampling rate, where the bandwidth or the sampling rate is used in a physical layer and a media access control (MAC) layer of the interface circuit, and where a filter bandwidth of a filter in the interface circuit (such as an analog filter) is modified to accommodate the bandwidth or the sampling rate.

### CROSS REFERENCE TO RELATED APPLICATIONS

This application claims priority under 35 U.S.C. 119(e) to U.S. Provisional Application Ser. No. 63/088,155, “Modified Interface Circuit with Enhanced Communication Performance,” filed on Oct. 6, 2020, by Sundar Sankaran, the contents of which are herein incorporated by reference.

### FIELD

The described embodiments relate to techniques for an access point to provide enhanced communication performance using a modified interface circuit that is compatible with an existing wireless standard.

### BACKGROUND

Many electronic devices are capable of wirelessly communicating with other electronic devices. For example, these electronic devices can include a networking subsystem that implements a network interface for: a cellular network (UMTS, LTE, etc.), a wireless local area network or WLAN (e.g., a wireless network such as described in the Institute of Electrical and Electronics Engineers (IEEE) 802.11 standard or Bluetooth™ from the Bluetooth Special Interest Group of Kirkland, Wash.), and/or another type of wireless network.

Typically, communication performance in a wireless network is constrained by the capabilities of the latest interface circuits or radios. Notably, at a given time, the latest interface circuits for an IEEE 802.11-compatible wireless network or WLAN are compatible with a most-recent approved IEEE 802.11 standard, such as IEEE 802.11ax (which is sometimes referred to as ‘Wi-Fi 6’). For IEEE 802.11ax, this means that the interface circuits are allowed to use up to 160 MHz of bandwidth or a sampling rate of up to 320 MHz, which places an upper bound of the throughput. If users want to have improved communication performance, they usually have to wait for a new IEEE 802.11 standard to be approved and compatible interface circuits to be designed and fabricated. Thus, if users want to have improved communication performance relative to IEEE 802.11ax, they may need to wait for IEEE 802.11be (which is sometimes referred to as ‘Wi-Fi 7’) to be finalized and for compatible silicon chips to be produced, which are expected to take 4-5 years.

### SUMMARY

An electronic device is described. This electronic device includes an interface circuit that wirelessly communicates with a second electronic device, where the interface circuit is compatible with an existing IEEE 802.11 standard having a predefined maximum bandwidth or a corresponding predefined maximum sampling rate. During operation, the interface circuit may communicate with the second electronic device using a bandwidth or a corresponding sampling rate that exceeds the predefined maximum bandwidth or the predefined maximum sampling rate, where the bandwidth or the sampling rate is used in a physical layer and a media access control (MAC) layer of the interface circuit, and where a filter bandwidth of a filter in the interface circuit is modified relative to requirements associated with the existing IEEE 802.11 standard in order to accommodate the bandwidth or the sampling rate.

For example, the bandwidth or the sampling rate may be greater than or equal to a multiple (or a multiplication factor) of the predefined maximum bandwidth or the predefined maximum sampling rate. Notably, the multiple may be an integer, such as two. In some embodiments, the existing IEEE 802.11 standard may be IEEE 802.11ax, the predefined maximum bandwidth may be 160 MHz, and the predefined maximum sampling rate may be 320 MHz.

Moreover, the filter bandwidth may be increased by the multiple. In some embodiments, the filter may be an analog filter. Note that the filter bandwidth of the analog filter may be selected or programmed. In some embodiments, a second filter bandwidth of a second filter in the interface circuit is modified relative to requirements associated with the existing IEEE 802.11 standard in order to accommodate the bandwidth or the sampling rate. Notably, the second filter may be a digital filter, and the second filter bandwidth of the second filter may be selected or programmed.

Furthermore, the communication may include transmitting and receiving packets or frames. Consequently, the bandwidth or the sampling rate may exceed the predefined maximum bandwidth or the predefined maximum sampling rate on both sides of a link with the second electronic device.

Additionally, the electronic device may include an access point and the second electronic device may include a second access point. In some embodiments, the access point may include a root access point (which provides wired communication with another network, such as the Internet) in a mesh network and the second access point may include a mesh access point in the mesh network. Alternatively, the electronic device may include an access point and the second electronic device may include a client or a station, which is associated with the access point.

Note that the interface circuit may communicate in two or more bands of frequencies, such as 2.4 GHz, 5 GHz and/or 6 GHz. Consequently, in some embodiments, the communication occurs in a 6 GHz band of frequencies.

In some embodiments, the bandwidth or the sampling rate is implemented by changing a clock in or associated with the interface circuit. For example, the clock may be changed by selecting or programing a first integer M that multiples a reference clock, and/or a second integer N that divides the reference clock. Alternatively or additionally, the clock may be changed by providing a different reference clock to the interface circuit.

Another embodiment provides the interface circuit.

Another embodiment provides the second electronic device.

Another embodiment provides a computer-readable storage medium for use with the electronic device or the second electronic device. This computer-readable storage medium may include program instructions that, when executed by the electronic device or the second electronic device, cause the electronic device or the second electronic device to perform at least some of the aforementioned operations.

Another embodiment provides a method. This method includes at least some of the operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for communicating with a second electronic device in the system in FIG. 1 in accordance with an embodiment of the present disclosure.

FIG. 3 is a drawing illustrating an example of communication among electronic devices in FIG. 1 in accordance with an embodiment of the present disclosure.

FIG. 4 is a drawing illustrating an example of an integrated circuit in accordance with an embodiment of the present disclosure.

FIG. 5 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device (such as an access point) is described. This electronic device includes an interface circuit that wirelessly communicates with a second electronic device (such as another access point or a client or station that is associated with the access point), where the interface circuit is compatible with an existing IEEE 802.11 standard having a predefined maximum bandwidth or a corresponding predefined maximum sampling rate. During operation, the interface circuit may communicate with the second electronic device using a bandwidth or a corresponding sampling rate that exceeds the predefined maximum bandwidth or the predefined maximum sampling rate, where the bandwidth or the sampling rate is used in a physical layer and a media access control (MAC) layer of the interface circuit, and where a filter bandwidth of a filter in the interface circuit (such as an analog filter) is modified relative to requirements associated with the existing IEEE 802.11 standard in order to accommodate the bandwidth or the sampling rate. For example, the bandwidth or the sampling rate may be greater than or equal to a multiple (such as two) of the predefined maximum bandwidth or the predefined maximum sampling rate.

By communicating with the second electronic device using the bandwidth or the corresponding sampling rate, these communication techniques may offer improved communication performance. For example, the communication techniques may have a higher throughput that the existing IEEE 802.11 standard without requiring a new silicon chip (or a new interface circuit). Thus, the communication techniques may allow users to leverage the low-cost and wide-spread availability of interface circuits that are compatible with the existing IEEE 802.11 standard, while not requiting the users to wait for a new IEEE 802.11 standard and new interface circuits to be designed and fabricated in order to obtain improved communication performance. Consequently, the communication techniques may improve the user experience when using the electronic device, the second electronic device and an associated wireless network or WLAN.

In the discussion that follows, electronic devices or components in a system communicate packets or frames in accordance with a wireless communication protocol, such as: a wireless communication protocol that is compatible with an IEEE 802.11 standard (which is sometimes referred to as ‘Wi-Fi®,’ from the Alliance of Austin, Tex.), Bluetooth, and/or another type of wireless interface (such as another wireless-local-area-network interface). Moreover, an access point in the system may communicate with a controller or services using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

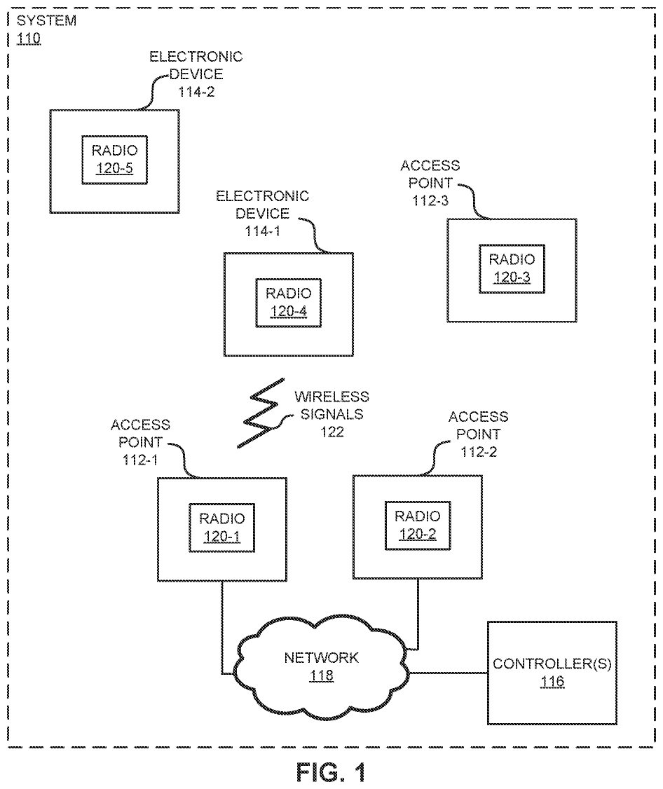

We now describe some embodiments of the communication techniques. FIG. 1 presents a block diagram illustrating an example of a system 110, which may include components, such as: one or more access points 112, one or more electronic devices 114 (such as cellular telephones, stations or clients, another type of electronic device, etc.), and one or more optional controllers 116. In system 110, one or more of the one or more access points 112 may wirelessly communicate with one or more of the one or more electronic devices 114 using wireless communication that is compatible with an IEEE 802.11 standard. Thus, the wireless communication may occur in, e.g., a 2.4 GHz, a 5 GHz, a 6 GHz and/or a 60 GHz frequency band. (Note that IEEE 802.11ad communication over a 60 GHz frequency band is sometimes referred to as ‘WiGig.’ In the present discussion, these embodiments are also encompassed by ‘Wi-Fi.’) However, a wide variety of frequency bands may be used. Moreover, the one or more access points 112 may communicate with the one or more optional controllers 116 via network 118 (such as the Internet, an intra-net and/or one or more dedicated links). Note that the one or more optional controllers 116 may be at the same location as the other components in system 110 or may be located remotely (i.e., at a different location). Moreover, note that the one or more access points 112 may be managed and/or configured by the one or more optional controllers 116. Furthermore, note that at least one of the one or more access points 112 may provide access to network 118 (e.g., via an Ethernet protocol), and may be a physical access point or a virtual or ‘software’ access point that is implemented on a computer or an electronic device. In some embodiments, one or more of access points 112 (such as access point 112-3) may communicate wirelessly with at least another of access points 112 (such as access point 112-2). Thus, access point 112-3 may be a mesh access point in a mesh network, and access point 112-2 may be a root access point in the mesh network. While not shown in FIG. 1, there may be additional components or electronic devices, such as a router.

Additionally, as noted previously, the one or more access points 112 and the one or more electronic devices 114 may communicate via wireless communication. Notably, one or more of access points 112 and one or more of electronic devices 114 may wirelessly communicate while: transmitting advertising frames on wireless channels, detecting one another by scanning wireless channels, exchanging subsequent data/management frames (such as association requests and responses) to establish a connection, configure security options (e.g., Internet Protocol Security), transmit and receive frames or packets via the connection (which may include the association requests and/or additional information as payloads), etc.

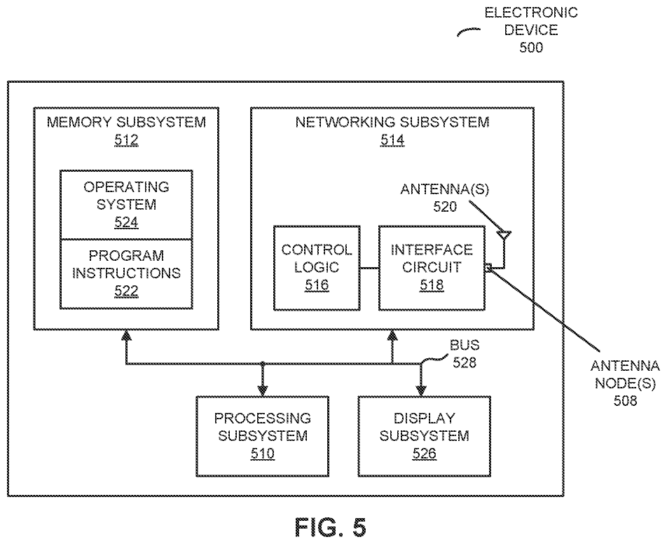

As described further below with reference to FIG. 5, the one or more access points 112, the one or more electronic devices 114 and/or the one or more optional controllers 116 may include subsystems, such as a networking subsystem, a memory subsystem and a processor subsystem. In addition, the one or more access points 112 and the one or more electronic devices 114 may include radios 120 in the networking subsystems. More generally, the one or more access points 112 and the one or more electronic devices 114 can include (or can be included within) any electronic devices with the networking subsystems that enable the one or more access points 112 and the one or more electronic devices 114 to wirelessly communicate with each other.

As can be seen in FIG. 1, wireless signals 122 (represented by a jagged line) are transmitted from a radio 120-4 in electronic device 114-1. These wireless signals are received by a radio in at least one of the one or more access points 112, such as radio 120-1 in access point 112-1. Notably, electronic device 114-1 may transmit frames or packets. In turn, these frames or packets may be received by access point 112-1. This may allow electronic device 114-1 to communicate information to access point 112-1. (Similarly, access points 112-2 and 112-3 may communicate packets or frames with each other.) Note that the communication between electronic device 114-1 and access point 112-1 (or between access points 112-2 and 112-3) may be characterized by a variety of performance metrics, such as: a data rate, a data rate for successful communication (which is sometimes referred to as a ‘throughput’), an error rate (such as a retry or reseed rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 120 are shown in the one or more electronic devices 114 and the one or more access points 112, one or more of these instances may be different from the other instances of radios 120.

As noted previously, the communication performance of electronic devices in a wireless network or WLAN is typically constrained by the current or latest available interface circuits or radios 120. In turn, the capabilities of the latest available interface circuits are often specified by an existing IEEE 802.11 standard. Thus, in order to obtain improved communication performance, a user usually needs to wait for a new IEEE 802.11 standard to be approved and compatible interface circuits to be designed and fabricated.

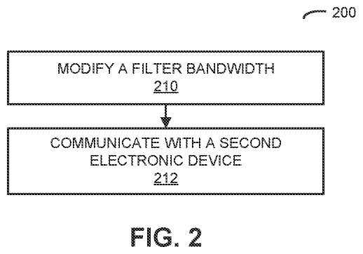

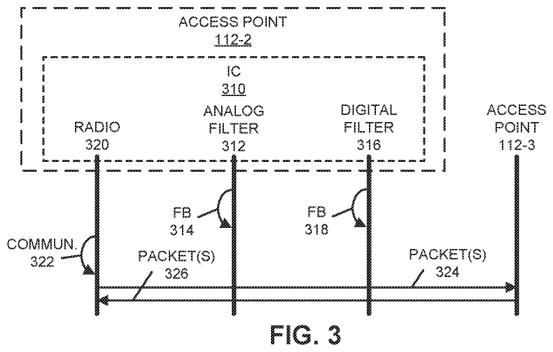

In order to address these challenges, the communication techniques allow the current or latest interface circuits that are compatible with an existing IEEE 802.11 standard to be modified to provide improved communication performance, such as larger data rates or throughput. Notably, as discussed further below with reference to FIGS. 2-3, the communication techniques may be implemented in two or more of access points 112, such as access points 112-2 and 112-3. In the discussion that follows, radio 120-2 and access point 112-2 are used as illustrations of the communication techniques.

In access point 112-2, radio 120-2 may be compatible with an existing IEEE 802.11 standard having a predefined maximum bandwidth or a corresponding predefined maximum sampling rate. In some embodiments, the existing IEEE 802.11 standard may be IEEE 802.11ax, the predefined maximum bandwidth may be 160 MHz, and the predefined maximum sampling rate may be 320 MHz. Moreover, during operation, radio 120-2 may wirelessly communicate one or more packets or frames with access point 112-3 using a bandwidth or a corresponding sampling rate that exceeds the predefined maximum bandwidth or the predefined maximum sampling rate, where the bandwidth or the sampling rate is used in a physical layer and a MAC layer of radio 120-2. For example, the bandwidth or the sampling rate may be greater than or equal to a multiple or a multiplication factor of the predefined maximum bandwidth or the predefined maximum sampling rate. In some embodiments, the multiple or the multiplication factor is an integer (such as two). More generally, the multiple or the multiplication factor is a real number that is greater than one and less than an upper bound (which may be associated with the existing IEEE 802.11 standard aid/or a regulatory requirement from a government agency, such as the Federal Communications Commission).

In order to operate using the bandwidth or the sampling rate, a clock in or associated with radio 120-2 may be changed or modified. Notably, the clock may be at least the multiple (such as two) of a clock associated with the existing IEEE 802.11 standard. For example, the clock may be changed by selecting or programing a first integer M that is used by radio 120-2 to multiply a reference clock, and/or a second integer N that is used by radio 120-2 to divide the reference clock. Alternatively or additionally, the clock may be changed by providing a different reference clock to radio 120-2, such as by using a different crystal oscillator. Thus, in the communication techniques, the clock may be changed by making modification internal to and/or external to radio 120-2.

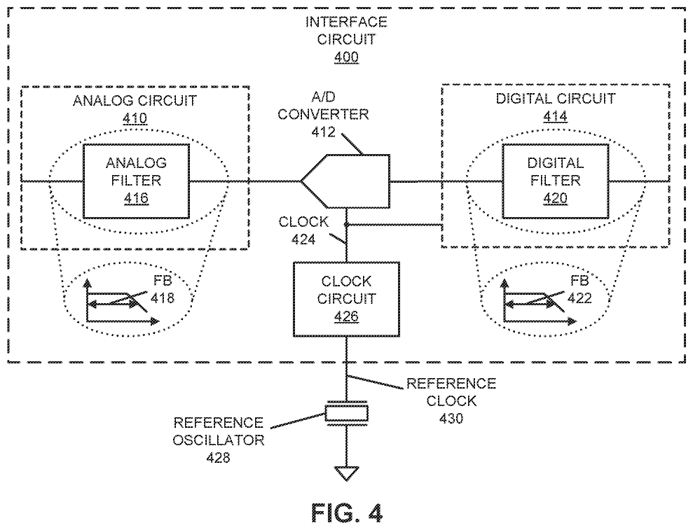

Furthermore, as described further below with reference to FIG. 4, in a receive path radio 120-2 may include an analog circuit and, after analog-to-digital (A/D) conversion (or vice versa for a transmit path), a digital circuit. The analog circuit may include an analog filter and the digital circuit may include a digital filter. In order to operate using the bandwidth or the sampling rate, a filter bandwidth of the analog filter may be modified relative to requirements associated with the existing IEEE 802.11 standard. For example, the filter bandwidth of radio 120-2 may be selected or programmed. Additionally, the analog bandwidth may be at least the multiple (such as two) of an analog bandwidth associated with the existing IEEE 802.11 standard.

In some embodiments, when the clock is changed or modified, a second filter bandwidth of the digital filter may be automatically modified by radio 120-2 relative to requirements associated with the existing IEEE 802.11 standard. For example, if the clock is the multiple (such as two) of a clock associated with the existing IEEE 802.11 standard, then the second filter bandwidth may be at least the multiple (such as two) of a second filter bandwidth associated with the existing IEEE 802.11 standard. However, in some embodiments, the second filter bandwidth is not automatically modified by radio 120-2. In these embodiments, the second filter bandwidth may be selected or programmed.

Note that the communication between access points 112-2 and 112-3 may include transmitting and receiving the one or more packets or frames. Consequently, the bandwidth or the sampling rate may exceed the predefined maximum bandwidth or the predefined maximum sampling rate on both sides of a link between access points 112-2 and 112-3.

Moreover, note that radio 120-2 may communicate in two or more bands of frequencies, such as 2.4 GHz, 5 GHz and/or 6 GHz. Consequently, in some embodiments, the communication of the one or more packets or frames occurs in a 6 GHz band of frequencies.

While the preceding discussion illustrated the communication techniques with a common multiple or multiplication factor for the bandwidth or the sampling rate, the clock, the filter bandwidth and the second filter bandwidth, in other embodiments two or more different multiples or multiplication factors may be used (such as a first multiple for the clock, a second multiple for the filter bandwidth, etc.), so long as the resulting capabilities of radio 120-2 are compatible with the desired bandwidth or the sampling rate.

Moreover, while the preceding discussion illustrated the use of the communication techniques during communication between access points 112-2 and 112-3, in other embodiments the communication techniques may be used during communication between an access point (such as access point 112-1) and one of electronic devices 114 (such as electronic device 114-1),

In some embodiments, the existing IEEE 802.11ax standard includes IEEE 802.11ax. This may mean that radio 120-2 is allowed to use up to 160 MHz of bandwidth or a sampling rate of up to 320 MHz, which places an upper bound of the throughput. More generally, the communication techniques may be used with a wide variety of IEEE 802.11 standards as the ‘existing IEEE 802.11 standard,’ including one or more of: IEEE 802.11a, IEEE 802.11b, IEEE 802.11g, IEEE 802.11n, IEEE 802.11ac, IEEE 802.11ax, or IEEE 802.11be.

In these ways, the electronic devices that use the communication techniques may provide improved communication performance while leveraging existing integrated circuits (and, thus, do not require new silicon or new chips). Consequently, the communication techniques may improve communication performance when using access point 112-2, access point 112-3 electronic device 114-1 and the associated WLAN, and thus may provide an improved user experience.

In the described embodiments, processing a frame or a packet in a given one of the one or more access points 112 or a given one of the one or more electronic devices 114 may include: receiving wireless signals 122 with the frame or packet; decoding/extracting the frame or packet from the received wireless signals 122 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components, Therefore, in some embodiments there may be fewer or additional instances of at least some of the one or more access points 112, the one or more electronic devices 114 and/or the one or more optional controllers 116. As another example, in another embodiment, different electronic devices are transmitting and/or receiving frames or packets.

We now describe embodiments of the method. FIG. 2 presents an example of a flow diagram illustrating an example method 200 for communicating with a second electronic device. Moreover, method 200 may be performed by an electronic device, such as one of the one or more access points 112 in FIG. 1, e.g., access point 112-2.

During operation, the electronic device may modify a filter bandwidth (operation 210) of a filter in an interface circuit in the electronic device relative to requirements associated with an existing IEEE 802.11 standard in order to accommodate a bandwidth or a corresponding sampling rate that exceeds a predefined maximum bandwidth or a corresponding predefined maximum sampling rate of the existing IEEE 802.11 standard, where the interface circuit is compatible with the existing IEEE 802.11 standard.

For example, the bandwidth or the sampling rate may be greater than or equal to a multiple of the predefined maximum bandwidth or the predefined maximum sampling rate. Notably, the multiple may be an integer, such as two. Moreover, the filter bandwidth may be increased by at least the multiple. In some embodiments, the filter may be an analog filter. Note that the filter bandwidth of the analog filter may be selected or programmed. In some embodiments, a second filter bandwidth of a second filter in the interface circuit is modified relative to requirements associated with the existing IEEE 802.11 standard in order to accommodate the bandwidth or the sampling rate. Notably, the second filter may be a digital filter, and the second filter bandwidth of the second filter may be selected or programmed. In some embodiments, the existing IEEE 802.11 standard may be IEEE 802.11ax, the predefined maximum bandwidth may be 160 MHz, and the predefined maximum sampling rate may be 320 MHz.

Then, the electronic device may communicate with the second electronic device (operation 212) using the bandwidth or the sampling rate, where the bandwidth or the sampling rate is used in a physical layer and a MAC layer of the interface circuit. Furthermore, the communication may include transmitting and receiving packets or frames. Consequently, the bandwidth or the sampling rate may exceed the predefined maximum bandwidth or the predefined maximum sampling rate on both sides of a link with the second electronic device.

Additionally, the electronic device may include an access point and the second electronic device may include a second access point. In some embodiments, the access point may include a root access point (which provides wired communication with another network, such as the Internet) in a mesh network and the second access point may include a mesh access point in the mesh network. Alternatively, the electronic device may include an access point and the second electronic device may include a client or a station, which is associated with the access point.

Note that the interface circuit may communicate in two or more bands of frequencies, such as 2.4 GHz, 5 GHz and/or 6 GHz. Consequently, in some embodiments, the communication occurs in a 6 GHz band of frequencies.

In some embodiments, the bandwidth or the sampling rate is implemented by changing a clock in or associated with the interface circuit. For example, the clock may be changed by selecting or programing a first integer M that multiples a reference clock, and/or a second integer N that divides the reference clock. Alternatively or additionally, the clock may be changed by providing a different reference clock to the interface circuit.

In some embodiments of method 200, there may be additional or fewer operations. Moreover, there may be different operations. Furthermore, the order of the operations may be changed, and/or two or more operations may be combined into a single operation.

FIG. 3 presents a drawing illustrating an example of communication between access point 112-2 and access point 112-3. In FIG. 3, an integrated circuit (IC) 310 in access point 112-2 may modify a filter bandwidth (FB) 314 of an analog filter 312 in integrated circuit 310 relative to requirements associated with an existing IEEE 802.11 standard in order to accommodate a bandwidth or a corresponding sampling rate that exceeds a predefined maximum bandwidth or a corresponding predefined maximum sampling rate of the existing IEEE 802.11 standard. For example, filter bandwidth 314 may be selected or programmed.

Note that integrated circuit 310 may be compatible with the existing IEEE 802.11 standard. Moreover, the bandwidth or the sampling rate may be greater than or equal to a multiple of the predefined maximum bandwidth or the predefined maximum sampling rate. Notably, the multiple may be an integer, such as two. Furthermore, filter bandwidth 314 may be increased by at least the multiple.

In some embodiments, integrated circuit 310 may optionally modify a filter bandwidth 318 of a digital filter 316 in integrated circuit 310 relative to the requirements associated with the existing IEEE 802.11 standard in order to accommodate the bandwidth or the corresponding sampling rate that exceeds the predefined maximum bandwidth or the corresponding predefined maximum sampling rate of the existing IEEE 802.11 standard.

Then, a radio 320 in integrated circuit 310 may communicate 322 with access point 112-3 using the bandwidth or the sampling rate, where the bandwidth or the sampling rate is used in a physical layer and a MAC layer of integrated circuit 310. For example, radio 320 may transmit one or more packets 324 or frames to access point 112-3 and/or may receive one or more packets 326 or frames from access point 112-3.

While FIG. 3 illustrates some operations using unilateral or bilateral communication (which are, respectively, represented by one-sided and two-sided arrows), in general a given operation in FIG. 3 may involve unilateral or bilateral communication.

FIG. 4 presents a drawing illustrating an example of an integrated circuit 400. A receive path in integrated circuit 400 may include: an analog circuit 410, an A/D converter 412, and a digital circuit 414. Analog circuit 410 may include an analog filter 416 having a filter bandwidth 418 (which is illustrated in the transfer function in a first inset). Moreover, digital circuit 414 may include a digital filter 420 having a filter bandwidth 422 (which is illustrated in the transfer function in a second inset). Furthermore, A/D converter 412 may sample analog electrical signals from analog circuit 410 based at least in part on a clock 424 provided by clock circuit 426, where clock circuit 426 receives a reference clock 430 from a crystal oscillator 428, and may generate clock 424 by multiplying reference clock 430 by a first integer M and/or dividing reference clock 430 by a second integer N.

During the communication techniques, clock 424 may be modified or changed. For example, clock 424 may be increased by at least a multiple or a multiplication factor by selecting or programming the first integer M, selecting or programming the second integer N, and/or changing crystal oscillator 428. Moreover, filter bandwidth 418 may be increased by at least the multiple or the multiplication factor, e.g., by selecting or programming filter bandwidth 418. In some embodiments, filter bandwidth 422 may automatically be increased by at least the multiple or the multiplication factor when clock 424 is modified or changed. Alternatively, in some embodiments filter bandwidth 422 may be increased by at least the multiple or the multiplication factor by optionally selecting or programming filter bandwidth 422.

These changes in or associated with interface circuit 400 may allow interface circuit 400 to communicate one or more packets or frames using a bandwidth or a corresponding sampling rate that exceeds a predefined maximum bandwidth or a corresponding predefined maximum sampling rate of an existing IEEE 802.11 standard. For example, the bandwidth or the sampling rate may be the multiple of the predefined. maximum bandwidth or the predefined maximum sampling rate.

While FIG. 4 illustrates crystal oscillator 428 as being external to interface circuit 400, in other embodiments crystal oscillator 428 is included in interface circuit 400.

In some embodiments, the communication techniques may be used in a mesh network. A mesh network may be used in an environment (such as a home or a business) in order to extend wireless coverage. A root access point in the mesh network may provide wired backhaul (such as wired Ethernet), and a mesh access point in the mesh network may use a radio-frequency connection or link to the root access point as its backhaul. Typically, this link uses a Wi-Fi communication protocol. The maximum link speed may be achieved if the most-recent or latest interface circuit is used. Presently, the latest interface circuit is compatible with IEEE 802.11ax or Wi-Fi 6 and has a maximum bandwidth or channel of 160 MHz.

Recently, the FCC has opened up 1.2 GHz of spectrum in the 6 GHz band of frequencies between 5.9-7.2 GHz. This spectrum allows a bandwidth or channel of up to 320 MHz. In the communication techniques, by doubling the clock using in the physical and MAC layers of a 6 GHz interface circuits or radios in the root access point and the mesh access point, the signal bandwidth may be doubled from 160 MHz to 320 MHz (or the corresponding sampling rate may be at least doubled from 320 Mb/s to greater than or equal to 640 Mb/s). This may allow the capabilities of the spectrum in the 6 GHz band of frequencies to be exploited to the fullest and may maximize the mesh link throughput (e.g., the throughput may be doubled). Moreover, the communication techniques may allow the improved communication performance without requiring new silicon chips or a new IEEE 802.11 standard, because the clock frequencies at both ends of the link are increased by the same amount.

In some embodiments, in order to implement the communication techniques, the interface circuit or radio that is compatible with the existing IEEE 802.11 standard may need to be over designed. For example, the interface circuits or radios that are compatible with the existing IEEE 802.11 standard may binned, and interface circuits or radios that have the highest performance or margin may be used in the communication techniques.

We now describe embodiments of an electronic device, which may perform at least some of the operations in the communication techniques. For example, the electronic device may include a component in system 110, such as one of: the one or more access points 112, the one or more electronic devices 114 and/or the one or more optional controllers 116. FIG. 5 presents a block diagram illustrating an electronic device 500 in accordance with some embodiments. This electronic device includes processing subsystem 510, memory subsystem 512, and networking subsystem 514. Processing subsystem 510 includes one or more devices configured to perform computational operations. For example, processing subsystem 510 can include one or more microprocessors, ASICs, microcontrollers, programmable-logic devices, graphical processor units (GPUs) and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory (which collectively or individually are sometimes referred to as a ‘computer-readable storage medium’). In some embodiments, instructions for processing subsystem 510 in memory subsystem 512 include: one or more program modules or sets of instructions (such as program instructions 522 or operating system 524), which may be executed by processing subsystem 510. Note that the one or more computer programs may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as nodes 508, e.g., a pad, which can be coupled to the one or more antennas 520. Thus, electronic device 500 may or may not include the one or more antennas 520.) For example, networking subsystem 514 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 500 may be adapted or changed using pattern shapers (such as reflectors) in one or more antennas 520 (or antenna elements), which can be independently and selectively electrically coupled to ground to steer the transmit antenna radiation pattern in different directions. Thus, if one or more antennas 520 includes N antenna-radiation-pattern shapers, the one or more antennas 520 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting frames and/or scanning for frames transmitted by other electronic devices.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments program instructions 522 are included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 514. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated. as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for interface circuit 518) or in firmware in interface circuit 518. Alternatively or additionally, at least some of the operations in the communication techniques may be implemented in a physical layer, such as hardware in interface circuit 518.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 6 GHz, 60 GHz, and/or a band of frequencies used by a Citizens Broadband Radio Service or by LTE. In some embodiments, the communication between electronic devices uses multi-user transmission (such as orthogonal frequency division multiple access or OFDM).

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1 An electronic device, comprising:
an antenna; and
an interface circuit, coupled to the antenna, configured to communicate with a second electronic device, wherein the interface circuit is compatible with an existing Institute of Electrical and Electronics Engineers (IEEE) 802.11 standard having a predefined maximum bandwidth or a corresponding predefined maximum sampling rate, and wherein the interface circuit is configured to:
communicate with the second electronic device using a bandwidth or a corresponding sampling rate that exceeds the predefined maximum bandwidth or the predefined maximum sampling rate, wherein the bandwidth or the sampling rate is used in a physical layer and a media access control (MAC) layer of the interface circuit, and wherein a filter bandwidth of a filter in the interface circuit is modified relative to requirements associated with the existing IEEE 802.11 standard in order to accommodate the bandwidth or the sampling rate.

2. The electronic device of claim 1, wherein the bandwidth or the sampling rate is greater than or equal to a multiple of the predefined maximum bandwidth or the predefined maximum sampling rate.

3. The electronic device of claim 2, wherein the multiple is two.

4. The electronic device of claim 2, wherein the filter bandwidth is increased by the multiple.

5. The electronic device of claim 1, wherein the existing IEEE 802.11 standard comprises IEEE 802.11ax, the predefined maximum bandwidth is 160 MHz, and the predefined maximum sampling rate is 320 MHz.

6. The electronic device of claim 1, wherein the filter comprises an analog filter and the filter bandwidth of the analog filter is selected or programmed.

7. The electronic device of claim 6, wherein a second filter bandwidth of a second filter in the interface circuit is modified relative to requirements associated with the existing IEEE 802.11 standard in order to accommodate the bandwidth or the sampling rate.

8. The electronic device of claim 7, wherein the second filter comprises a digital filter, and the second filter bandwidth of the second filter is selected or programmed.

9. The electronic device of claim 1, wherein the communication comprises transmitting and receiving packets or frames.

10. The electronic device of claim 1, wherein the electronic device comprises an access point and the second electronic device comprises a second access point.

11. The electronic device of claim 1, wherein the electronic device comprises an access point and the second electronic device comprises a client or a station, which is associated with the access point.

12. The electronic device of claim 1, wherein the interface circuit communicates with the electronic device in two or more hands of frequencies.

13. The electronic device of claim 1, wherein the interface circuit communicates with the electronic device in a 6 GHz band of frequencies.

14. The electronic device of claim 1, wherein the bandwidth or the sampling rate is implemented by changing a clock in or associated with the interface circuit.

15. The electronic device of claim 14, wherein the clock is changed by selecting or programing a first integer M that multiples a reference clock, a second integer N that divides the reference clock, or both.

16. The electronic device of claim 14, wherein the clock is changed by providing a different reference clock to the interface circuit.

17. A non-transitory computer-readable storage medium for use in conjunction with an electronic device, the computer-readable storage medium storing program instructions, wherein, when executed by the electronic device, the program instructions cause the electronic device to perform one or more operations comprising:
modifying a filter bandwidth of a filter in an interface circuit in the electronic device relative to requirements associated with an existing Institute of Electrical and Electronics Engineers (IEEE) 802.11 standard in order to accommodate a bandwidth or a corresponding sampling rate that exceeds a predefined maximum bandwidth or a corresponding predefined maximum sampling rate of the existing IEEE 802.11 standard, wherein the interface circuit is compatible with the existing IEEE 802.11 standard; and
communicating with a second electronic device using the bandwidth or the sampling rate, wherein the bandwidth or the sampling rate is used in a physical layer and a media access control (MAC) layer of the interface circuit.

18. The non-transitory computer-readable storage medium of claim 17, wherein the communicating comprises transmitting and receiving packets or frames.

19. A method for communicating with a second electronic device, comprising:
by an electronic device:
modifying a filter bandwidth of a filter in an interface circuit in the electronic device relative to requirements associated with an existing Institute of Electrical and Electronics Engineers (IEEE) 802.11 standard in order to accommodate a bandwidth or a corresponding sampling rate that exceeds a predefined maximum bandwidth or a corresponding predefined maximum sampling rate of the existing IEEE 802.11 standard, wherein the interface circuit is compatible with the existing IEEE 802.11 standard; and
communicating with the second electronic device using the bandwidth or the sampling rate, wherein the bandwidth or the sampling rate is used in a physical layer and a media access control (MAC) layer of the interface circuit.

20. The method of claim 19, wherein the communicating comprises transmitting and receiving packets or frames.
